(19) United States
(12) Patent Application Publication
(10) Pub. No.: US 2007/0064689 A1
(43) Pub. Date: Mar. 22, 2007

(54) Method of controlling communication between devices in a network and apparatus for the same

(76) Inventors: Yong Man Shin, Gyeonggi-do (KR); Seok Chul Song, Seoul (KR); Yong Tae Shin, Seoul (KR); Yong Jun Ju, Gyeonggi-do (KR)

Correspondence Address: OSTROLENK FABER GERB & SOFFEN, 1180 AVENUE OF THE AMERICAS, NEW YORK, NY, 100368403, US

(21) Appl. No.: 10/572,085

(22) PCT Filed: Sep. 16, 2004
(86) PCT No.: PCT/KR04/02367

§ 371 Date: Mar. 16, 2006

(30) Foreign Application Priority Data
Sep. 19, 2003 (KR) 10-2003-0065249

(51) Int. Cl. H04L 12/56

(52) U.S. Cl. 370/389; 370/395.54

(57) ABSTRACT

Disclosed is a technology by which rules on communication permission or control are enforced to network internal devices such that an environment which looks as if to have a virtual firewall existing between network internal devices can be established. A communication control apparatus for this is located on the same level in the network as other devices are located. By using this communication control apparatus, an address resolution protocol (ARP) packet in which a data link layer address is manipulated is provided to devices that are the objects of communication cut-off, such that data packets transmitted by the communication cut-off object devices are transmitted to manipulated abnormal addresses. By doing so, communication with the communication cut-off object devices is cut off. For a device which is in a communication cut-off state although the device is not an object of communication cut-off any more, the communication control apparatus transmits an ARP packet including normal address information to the device such that the communication cut-off state is canceled.

### TECHNICAL FIELD

The present invention relates to a technology for controlling communication between internal devices of a network, and more particularly, to a technology by which rules on communication permission or control are enforced to network internal devices such that an environment which looks as if to have a virtual firewall existing between network internal devices can be established.

### BACKGROUND ART

In a network environment becoming more complicated and diversified, it is needed to administer and control huge network resources in a more efficient and integrated manner by a limited number of human resources. If manually administered, networks resources, such as Internet protocol (IP) addresses, media access control (MAC) addresses, and host IDs, would cause waste of human resources and degradation of operational efficiency. In addition, illegal use of a network user's IP by a third person can cause a failure in which the IP collides against the IP of the existing network devices.

Generally, an enterprise or a factory uses a local area network (LAN) for efficiency of an operation or improvement of productivity. In a LAN, tens to thousands of devices, such as personal computers (PCs), workstations, robots, printers, and servers, (hereinafter, referred to as ‘network internal devices’) are linked. While permitting communication between these network internal devices without any restrictions may be useful in terms of operational efficiency and convenience, it may also cause some problems. That is, if communication between network internal devices is not appropriately restricted, a lot of unnecessary data packets become to be traveling on the LAN and this causes network resources to be used more than required, and causes waste of the resources. Also, if there is no control over use of network resources and freedom of communication, such actions as leakage of information between network internal users with an illicit purpose, hacking, and cracking, can be performed without any restrictions. Accordingly, in an enterprise or factory operating based on a LAN environment, it is needed to appropriately control communication of each of devices linked to the LAN with other devices. For this, a means capable of controlling communication right between network internal resources is needed.

A most widely used means for controlling communication is a firewall server. In the conventional firewall server system, the firewall server is located on the gateway position at which a network (hereinafter referred to as an ‘internal network’) is connected to an external network hereinafter referred to as an ‘external network’) and plays a role of controlling communication between a device connected to the external network with network internal devices of the internal network.

However, since the conventional firewall server is located at an entrance, that is, at a gateway, through which an internal network can be accessed, to control communication, control of communication with an external network, for example, cutting off communication, can be performed but control of communication between network internal devices is impossible. Also, the conventional firewall server lacks awareness of necessity of controlling communication between network internal devices. Furthermore, in the communication control method in which the control point is located at the gateway between an internal network and an external network, a communication control rule should be applied uniformly to the entire devices linked to the internal network. As a result, even devices that do not need to be controlled or restricted in relation to communication should also perform communication always through the firewall server. Accordingly, the firewall server should process unnecessary loads such that the communication speed between the internal network and the external network decreases.

Considering these problems, a means capable of effectively restricting communication between network internal devices disposed inside a network, which cannot be performed in the conventional firewall server, is strongly needed.

### DISCLOSURE OF THE INVENTION

To solve the above problems, it is an objective of the present invention to provide an apparatus which is connected to network internal devices in a network on the same level as that of the network internal devices and is capable of controlling communication between the network internal devices, and a method by which a network administrator of the network can control communication between the network internal devices by using the apparatus when necessary.

The basic concept of the present invention is that an administrator of a predetermined network sets a communication control rule by using a communication control apparatus of the present invention linked to the network on the same level as that of other devices of the network, and the set communication control rule is compulsorily applied to communication between devices of the network, that is, network internal devices, such that network internal communication between devices that are the object of control is controlled according to the set communication control rule.

According to an aspect of the present invention to accomplish the above-mentioned object, there is provided a communication control method for controlling communication between devices on a predetermined network by using a communication control apparatus located on the same level as other devices of the network. The method includes the steps of: determining at least a cut-off object device of which communication is needed to be cut-off, according to a set communication control rule; and providing an address resolution protocol (ARP) packet in which a data link layer address is manipulated, to the cut-off object device, wherein the cut-off object device is controlled to transmit its data packets to manipulated abnormal addresses, and by doing so, communication by the cut-off object device is cut off.

It is preferred that the communication control method further includes a step of transmitting an ARP packet including normal address information to a device which is in a communication cut-off state although the device is not an object of communication cut-off any more, such that the communication cut-off state is canceled.

It is also preferred that the communication control method further includes a step of setting part or all of the data link layer addresses of the cut-off object devices to the data link layer address of the communication control apparatus or a third data link layer address that is not of the cut-off object devices, such that communication between cut-off object devices is cut off.

Furthermore, it is also preferred that the communication control method further includes a step of, if there is collision between the Internet protocol (IP) address of a device newly connected to the predetermined network and the IP addresses of existing devices, transferring a correct IP address to the existing devices in a unicast method such that the collision of the IP address is prevented.

Furthermore, it is also preferred that the communication control method further includes a step of collecting network layer addresses and data link layer addresses of network internal devices for which the communication control rule is set. The step of collecting address is performed by a first method in which the communication control apparatus receives an ARP packet broadcast by a device in the network in order to communicate with any other device in the network, and detects a network layer address and a data link layer address included in the packet, and/or by a second method in which based on the address of an administration object device which is manually input by a network administrator, the communication control apparatus transmits an ARP request packet and detects a network layer address and a data link layer address from an ARP reply packet transmitted by the administration object device in response to the ARP request packet.

According to a second aspect of the present invention to accomplish the above-mentioned object, there is provided a communication control method for controlling communication between devices on a predetermined network. The method includes the steps of: collecting network layer addresses and data link layer addresses existing in the network, by a communication control apparatus; storing communication control rules, which are set to perform desired communication control for collected addresses by a network administrator, in a communication control rule database (DB); detecting an address resolution protocol (ARP) packet transmitted by a device in the network in order to communicate with another device in the network; determining whether or not the detected ARP packet corresponds to a communication cut-off object, by referring to the communication control rule DB; and if the packet corresponds to the communication cut-off object, transmitting an ARP for communication cut-off, wherein communication between network internal devices can be selectively controlled when necessary.

In the method, it is preferred that collecting the addresses is performed by a first method in which the communication control apparatus receives an ARP packet broadcast by a device in the network in order to communicate with any other device in the network, and detects a network layer address and a data link layer address included in the packet, and/or by a second method in which based on the address of an administration object device which is manually input by a network administrator, the communication control apparatus transmits an ARP request packet and detects a network layer address and a data link layer address from an ARP reply packet transmitted by the administration object device in response to the ARP request packet.

In the method, the objects of setting the communication control rule preferably include communication between network layer addresses, communication between data link layer addresses, and communication between a network layer address and a data link layer address. In addition, it is preferred that the objects of setting the communication control rule further include communication between network layer address and network layer address groups, communication between data link layer address and data link layer address groups, communication between network layer addresses and data link layer address groups, communication between data link layer addresses and network layer address groups, and communication between network layer address groups and data link layer address groups.

Furthermore, when a reception side address is an object of cut-off, a cut-off packet is transmitted to the ‘same addresses’ as the reception protocol address. In addition, when a transmission side address is an object of cut-off, a cut-off packet is transmitted to ‘all’ protocol-data link layer addresses belonging to the same network as that of the transmission side protocol.

Preferably, the method further includes a step of, if a network internal device transmits an ARP reply packet in response to the ARP request packet transmitted by the communication control apparatus, retrieving an relation rule by using a transmission side address included in the detected reply packet, and if the retrieval result indicates that there is a cut-off rule for the transmission side address, transmitting a cut-off packet to all protocol-data link layer address DBs (DB-3) belonging to the same network as that of the transmission side protocol.

In addition, preferably, the method further includes a step of, for a device which is in a communication cut-off state although the device is not an object of communication cut-off any more with detection of a network layer packet, transmitting an ARP packet for canceling the communication cut-off state.

Advantageously, the communication control method may further includes one or more steps of: by referring to the communication control rule DB at regular time interval, transmitting an ARP request packet for communication cut-off/canceling communication cut-off according to a communication control rule registered in the DB; if a reception side data link layer address is a cut-off address and there is a packet forwarding rule for the address, forwarding the received protocol layer packet with having the destination address of the received protocol layer packet as a normal data link layer address; and if there is collision between the Internet protocol (IP) address of a device newly connected to the predetermined network and the IP addresses of existing devices, transferring a correct IP address to the existing devices in a unicast method such that the collision of the IP address is prevented.

On the other hand, to accomplish the above-mentioned object of the present invention, there is provided a communication control apparatus which is located on the same level as that of devices on a predetermined network; provides an environment where an administrator of the network can set a communication control rule capable of cutting off communication between the devices when necessary; while administering the set communication control rules in a database, provides an ARP packet in which the data link layer address is manipulated, to the devices that are set as the objects of communication cut-off, such that data packets transmitted by the communication cut-off object devices are made to be transmitted to an manipulated abnormal address; and by doing so, cuts off communication between the communication cut-off object devices.

According to such features of the present invention, unlike the conventional firewall server which when an external device desires communication with a predetermined network, is disposed at a location that is a connection gateway of the predetermined network and controls the communication, the communication control apparatus is disposed, not at the gateway of the communication path of the network, but at an arbitrary place inside the network, for example, on the same level as that of the other internal devices inside the network, and forcibly applies a communication control rule, which is based on manipulation of address information of an address resolution protocol (ARP) table, to devices requiring communication control such that communication of only those devices can be selectively controlled. By doing so, the function of the conventional firewall server, which in a predetermined network, cuts off unnecessary communication between network internal resources and external network resources, is performed, and at the same time, controlling communication between network internal resources is also enabled selectively as desired. Accordingly, use of network resources can be reduced, and in addition, unauthenticated leakage of information between internal devices can be prevented.

### BRIEF DESCRIPTION OF THE DRAWINGS

FIG. 1 is a diagram of an example of a system construction implementing a communication control method according to the present invention;

FIG. 2 is a schematic flow chart of the steps performed by a method according to the present invention for controlling communication between network internal devices connected to a local area network (LAN);

FIG. 3 is a diagram showing a method by which communication control device EQ-X sets a rule for controlling communication between two network internal devices, EQ-1 and EQ-2;

FIG. 4 is a diagram of a program module forming an agent program;

FIG. 5 is a flow chart showing a detailed execution process of address collecting step S10;

FIG. 6 is a flow chart showing a process for setting a rule for cutting off communication and a cut-off process according to the rule;

FIG. 7 is a flow chart showing a process for canceling an already set communication cut-off rule;

FIG. 8 is a flow chart showing a process for processing communication control between network internal devices according to a rule set in a communication control rule DB;

FIG. 9 is a flow chart showing details of a process for detecting a packet and collecting an address according to the detection;

FIG. 10 is a flow chart showing a process for processing communication control according to a detected packet;

FIG. 11 is a detailed flow chart of a processing routine following detection of an address resolution protocol (ARP) request packet in step S184 of FIG. 10;

FIG. 12 is a detailed flow chart of a processing routine following detection of an ARP reply packet in step S184 of FIG. 10;

FIG. 13 is a flow chart of a process following detection of a protocol layer packet;

FIG. 14 is a detailed flow chart showing a packet forwarding step S250 of FIG. 13;

FIG. 15 is a flow chart of an address DB administration step (for example, step S192 of FIG. 11 and step S212 of FIG. 12) following detection of an ARP reply packet and an ARP request packet;

FIG. 16 is a flow chart of a process for retrieving and processing a communication control rule set for a combination of a protocol address and a data link layer address;

FIGS. 17 and 18 are flow charts of processes for retrieving and processing a communication control rule according to a protocol address and a data link layer address; and

FIG. 19 is a flow chart of a route through which addresses of network internal devices are detected, and stored and managed in a database.

### BEST MODE FOR CARRYING OUT THE INVENTION

For example, communication between resources linked to a predetermined network such as a LAN is performed, by using an address resolution protocol (ARP). The ARP is a protocol to be used to match a network layer address (for example, a protocol layer (L3) address such as an IP address) to a physical address (for example, a data link layer (L2) address such as a MAC address). Here, the physical address means, for example, a 48-bit network card address of Ethernet or token ring. An ARP packet is included as one part in Ethernet packet data. The header of an Ethernet packet includes a destination Ethernet address (48 bits), a source Ethernet address (48 bits), and an Ethernet protocol type (16 bits). At the back of this Ethernet packet header, an ARP packet is attached. When moving on a LAN, a packet is transmitted to a destination Ethernet address (for example, a MAC address). For reference, an ARP packet is formed as the following table 1:

TABLE 1
Structure of an ARP packet

| | Number | |
|---|---|---|
| Elements | of bytes | Contents |
| Hardware type | 2 | Indicates a hardware type used in a network |
| | | layer. In Ethernet, this value is 1. |
| Protocol type | 2 | Indicates a protocol used in a network layer. |
| Data link | 1 | Indicates the length of a hardware address |
| layer address | | in bytes. In Ethernet, this value is 6. |
| length | | |
| Protocol | 1 | Indicates the length of a protocol in bytes. |
| address | | In TCP/IP, this value is 4. |
| length | | |
| ARP class | 2 | This field specifies packet commands, such |
| code | | as ARP request, ARP response, RARP request, |
| | | and RARP response. |
| Transmission | n | Hardware address of a source. In most cases, |
| data link | | this is an Ethernet address. |
| layer address | | |
| Transmission | m | Internet address of a source |
| protocol | | |
| address | | |
| Reception | N | When an ARP request is generated, this |
| data link | | becomes a destination hardware address. |
| layer address | | Response provides a hardware address and |
| | | an Internet address of a destination device. |
| Reception | M | When an ARP request is generated, this |
| protocol | | becomes a destination Internet address. |
| address | | Response provides a hardware address and |
| | | an Internet address of a destination device. |

For example, when an IP host A desires to transmit an IP packet to IP host B, and does not know the physical address of IP host B, IP host A transmits, using an ARP protocol, an ARP packet having the IP address of IP host B that is the destination and a broadcasting physical address (FF:FF:FF:FF:FF:FF), on a network. If IP host B receives the ARP packet in which its IP address is recorded as the destination, IP host B responds to IP host A by transmitting the physical network layer address of IP host B. Thus collected IP addresses and corresponding physical network layer address information are stored in a memory called an ARP cache in each IP host in the form of a table (ARP table), and is again used when a next packet is transmitted. Resources connected to a network such as a LAN perform internal communication between them in this manner.

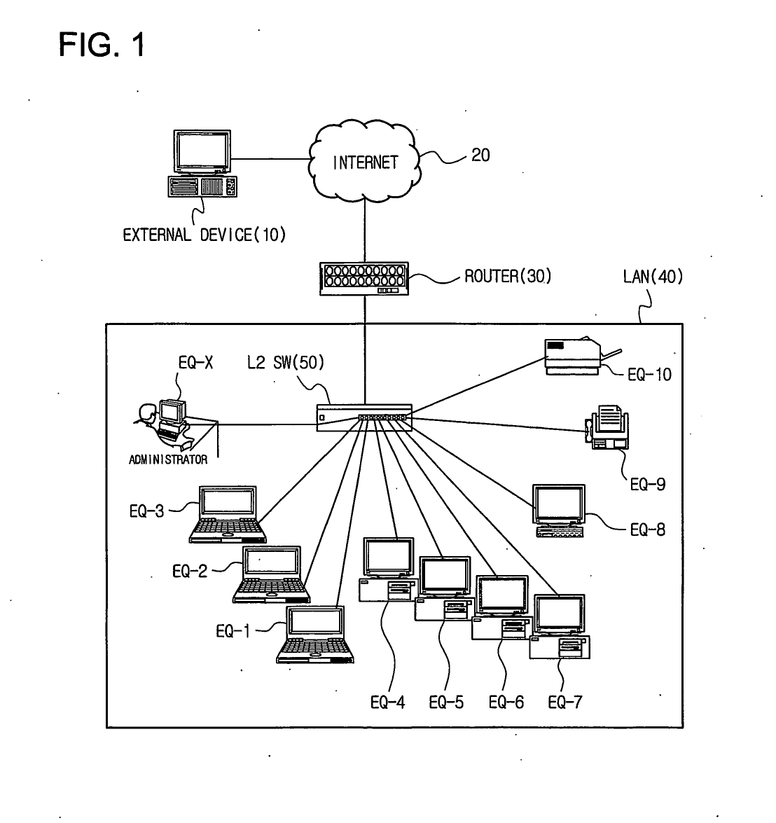

FIG. 1 is a diagram of an example of a system construction implementing a communication control method according to the present invention. In a LAN environment where a plurality of devices (EQ-1, EQ-2, . . . , EQ-10) are linked through a layer-2 switch 50, a communication control apparatus (EQ-X) according to the present invention is also linked on the same level as that of other devices (EQ-1, EQ-2, . . . , EQ-10), as a node linked to the LAN 40. However in this environment, by manipulating an ARP table with a method for controlling communication of a desired device, communication between internal devices of the LAN can be controlled as desired. The LAN 40 can be linked to the Internet 20 or another network (for example, another in-house virtual LAN (VLAN)) through a router 30.

In order for identical network layer devices to communicate with each other, a data link layer address is obtained by using an ARP protocol, and communication is performed therebetween by using the data link layer address. Network layer addresses and data link addresses are managed by an ARP table (network layer address-data link layer address), and when communication is required later, the addresses will be used.

In order to perform communication control in a network, such as ‘permission’/‘cut-off’/‘packet forwarding’ of communication between internal devices linked to the network, the ARP table should be generated such that the ARP table of each device can be manipulated, such as generating or modifying contents of the ARP table desired by the outside and the ARP table thus manipulated from the outside can be used when communication with a predetermined network layer address is required. Also, since each device desires to delete the ARP table or generates a new ARP request packet to obtain a data link layer address any time, this should also be appropriately processed. At this time, the most important thing is that when an ARP packet is generated so that the ARP table is generated or modified, it should not affect other devices and should apply only to a desired device. This is because communication control should be performed without affecting other devices that do not need control. For this, when a manipulated ARP address is provided to a communication control object node, unicast transmission method is used. Also, if communication is cut off by using a data link layer address, all on the network layer are cut off. Accordingly, forwarding network layer packets should be able to be performed when necessary. That is, for a network layer packet requiring communication, the communication control apparatus of the present invention should be able to relay the packet such that the packet is forwarded to be able to communicate.

In order to understand this communication control method, understanding of how communication between network internal devices on a LAN is performed should precede. In relation to this, a communication mechanism between network internal devices will now be explained as an example. By doing so, it can be understood how communication control apparatus EQ-X can control communication between network internal devices based on what principles.

For example, it is assumed that there is an environment in which network internal devices currently connected to the LAN 40 are EQ-1, EQ-2, and EQ-3, and communication control apparatus EQ-X is connected on the same level as that of these devices, and ARP tables in all devices are empty at first. It is also assumed that IP addresses and MAC addresses of these devices, EQ-1, EQ-2, EQ-3, and EQ-X, are NET-1(MAC-1), NET-2(MAC-2), NET-3(MAC-3) and NET-X(BLOCK), respectively. Here, a reception side address and a transmission side address are expressed in the form of ‘IP address (MAC address)’. Then, it is assumed that for communication between network internal devices, the following ARP request packets are transmitted. However, it is premised that ARP packets are transmitted not by a broadcast method F:FF:FF:FF:FF:FF), but by a unicast method.

(1) Process 1: A request packet (request packet-1) in which the destination MAC is MAC-1, and the reception side address and the transmission side address are NET-1(Null) and NET-2(BLOCK), respectively, is transmitted. For reference, request packet-1 can be regarded as an ARP request packet for communication of device EQ-2 with device EQ-1. Device EQ-1 corresponding to the destination MAC address (that is, MAC-1) of this request packet-1 receives this packet. Also, device EQ-1 recognizes that the MAC address of device EQ-2 is BLOCK. By this recognition, the packet which device EQ-1 transmits to device EQ-2 is actually received by communication control apparatus EQ-X whose MAC address is BLOCK

(2) Process 2: A request packet (request packet-2) in which the destination MAC is MAC-2, and the reception side address and the transmission side address are NET-2(MAC-2) and NET-1(BLOCK), respectively, is transmitted. For reference, this request packet-1 is received by device EQ-2 whose MAC address is MAC-2. Device EQ-2 recognizes that the MAC address of device EQ-1 is BLOCK. By this recognition, the packet which device EQ-2 transmits to device EQ-1 is actually received by communication control apparatus EQ-X whose MAC address is BLOCK.

(3) Process 3: A request packet (request packet-3) in which the destination MAC is MAC-3 and the reception side address and the transmission side address are NET-3(Null) and NET-1(MAC-1), respectively, is transmitted. This can be regarded as an ARP request packet for communication of device EQ-1 with device EQ-3.

(4) Process 4: A request packet (request packet-4) in which the destination MAC is MAC-3 and the reception side address and the transmission side address are NET-3(Null) and NET-2(MAC-2), respectively, is transmitted. This transmission processes can be put as the following table 2:

TABLE 2

| Transmission | | Destination | Reception | Transmission |
|---|---|---|---|---|
| process | Packet | MAC | address | address |
| Process 1 | Request | MAC-1 | NET-1(null) | NET-2(BLOCK) |
| | packet-1 | | | |
| Process 2 | Request | MAC-1 | NET-2(null) | NET-1(BLOCK) |
| | packet-2 | | | |
| Process 3 | Request | MAC-3 | NET-3(null) | NET-1(MAC-1) |
| | packet-3 | | | |
| Process 4 | Request | MAC-3 | NET-3(null) | NET-2(MAC-2) |
| | packet-4 | | | |

Devices that receive the four request packets transmitted through these transmission processes respond by transmitting reply packets as the following:

(5) Process 5: Device EQ-1 (NET-1, MAC-1) receiving ‘request packet-1’ transmits an ARP reply packet (reply packet-1) in which the transmission side is NET-1 (MAC-1), the reception side is NET-2(BLOCK), and the destination MAC is BLOCK, and newly generates the MAC address for NET-2 in the ARP table administered by itself, by recording the MAC address of NET-2 as BLOCK.

(6) Process 6: Device EQ-2 (NET-2, MAC-2) receiving ‘request packet-2’ transmits an ARP reply packet (reply packet-2) in which the transmission side is NET-2(MAC-2), the reception side is NET-1(BLOCK), and the destination MAC is BLOCK, and newly generates the MAC address for NET-1 in its ARP table, as BLOCK.

(7) Process 7: Device EQ-3 (NET-3, MAC-3) receiving ‘request packet-3’ transmits an ARP reply packet (reply packet-3) in which the transmission side is NET-3 (MAC-3), the reception side is NET-1(MAC-1), and the destination MAC is NET-1, and newly generates the MAC address for NET-1 in its ARP table, as MAC-1.

(8) Process 8: Device EQ-3 (NET-3, MAC-3) receiving ‘request packet-4’ transmits an ARP reply packet (reply packet-4) in which the transmission side is NET-3 (MAC-3), the reception side is NET-2(MAC-2), and the destination MAC is NET-2, and newly generates the MAC address for NET-2 in its ARP table, as MAC-2.

These response processes can be arranged as the following table 3:

TABLE 3

| | Packet/ | | |
|---|---|---|---|
| Response | Responding | | |
| process | device | Response contents | ARP table |
| Process 5 | Reply | Transmission side | Generate BLOCK |
| | packet-1/EQ-1 | address: NET-1(MAC-1) | as MAC address |
| | | Reception side | for NET-2 |
| | | address: NET-2(BLOCK) | |
| | | Destination MAC: | |
| | | BLOCK | |
| Process 6 | Reply | Transmission side | Generate BLOCK |
| | packet-2/EQ-2 | address: NET-2(MAC-2) | as MAC address |
| | | Reception side | for NET-1 |
| | | address: NET-1(BLOCK) | |
| | | Destination MAC: | |
| | | BLOCK | |
| Process 7 | Reply | Transmission side | Generate MAC-1 |
| | packet-3/EQ-3 | address: NET-3(MAC-3) | as MAC address |
| | | Reception side | for NET-1 |
| | | address: NET-1(MAC-1) | |
| | | Destination MAC: | |
| | | MAC-1 | |
| Process 8 | Reply | Transmission side | Generate MAC-2 |
| | packet-4/EQ-3 | address: NET-3(MAC-3) | as MAC address |
| | | Reception side | for NET-2 |
| | | address: NET-2(MAC-2) | |
| | | Destination MAC: | |
| | | MAC-2 | |

Next, in each of the devices receiving the above four reply packets, the following process is performed.

(9) Process 9: Communication control apparatus EQ-X receiving ‘reply packet-1’ newly generates MAC-1 as the MAC address for IP address NET-1 in the ARP table. For the reply packet-1 is transmitted with the reception side as MAC-1.

(10) Process 10: Communication control apparatus EQ-X receiving ‘reply packet-2’ newly generates MAC-2 as the MAC address of NET-2 in the ARP table.

(11) Process 11: Communication control apparatus EQ-1 receiving ‘reply packet-3’ newly generates MAC-3 as the MAC address for NET-3 in the ARP table.

(12) Process 12: Communication control apparatus EQ-2 receiving ‘reply packet-4’ newly generates MAC-3 as the MAC address for IP address NET-3 in the ARP table.

These processes can be arranged as the following table 4:

TABLE 4

| | | Received reply | |
|---|---|---|---|
| Process | Device | packet | Processing for ARP table |
| Process 9 | EQ-X | Reply packet-1 | Newly generate MAC-1 for NET-1 |
| Process 10 | EQ-X | Reply packet-2 | Newly generate MAC-2 for NET-2 |
| Process 11 | EQ-1 | Reply packet-3 | Newly generate MAC-3 for NET-3 |
| Process 12 | EQ-2 | Reply packet-4 | Newly generate MAC-3 for NET-3 |

ARP tables maintained in each of the devices after the above processes have the following changes in their contents.

(1) The entries maintained by device EQ-1 are NET-2(BLOCK) and NET-3(MAC-3) (table 1) processes 5 and 11).

(2) The entries maintained by device EQ-2 are NET-1(BLOCK) and NET-3(MAC-3) (table 2)(processes 6 and 12).

(3) The entries maintained by device EQ-3 are NET-1(MAC-1) and NET-2(MAC-2) (table 3)(processes 7 and 8).

(4) The entries maintained by device EQ-X are NET-1(MAC-1) and NET-2(MAC-2) (table 4)(processes 9 and 10).

These can be arranged as the following table 5:

TABLE 5

| | | | | Involved |
|---|---|---|---|---|
| Device | ARP table | Entry 1 | Entry 2 | process |
| EQ-1 | Table 1 | NET-2(BLOCK) | NET-3(MAC-3) | Process 5, |
| | | | | process 11 |
| EQ-2 | Table 2 | NET-1(BLOCK) | NET-3(MAC-3) | Process 6, |
| | | | | process 12 |
| EQ-3 | Table 3 | NET-1(MAC-1) | NET-2(MAC-2) | Process 7, |
| | | | | process 8 |
| EQ-X | Table 4 | NET-1(MAC-1) | NET-2(MAC-2) | Process 9, |
| | | | | process 10 |

In case of table 1 and table 3 that are the ARP tables of devices EQ-1 and EQ-3, respectively, tables 1 and 3 have BLOCK and MAC-2, respectively, as the MAC address of NET-2 that is the address of an identical device, device EQ-2. Accordingly, when device EQ-1 and device EQ-3 desire to transmit a packet to device EQ-2, destinations of the transmission packets become different to each other. Also, in case of table 2 and table 3 that are the ARP tables of devices EQ-2 and EQ-3, respectively, tables 1 and 3 have BLOCK and MAC-1, respectively, as the MAC address of an identical device, device EQ-1. Accordingly, when device EQ-2 and device EQ-3 desire to transmit a packet to device EQ-1, destinations of the transmission packets become different to each other. Therefore, while communication between devices EQ-1 and EQ-3 and communication between devices EQ-2 and EQ-3 can be performed normally, whether or not communication between devices EQ-1 and EQ-2 is possible is determined by a communication control rule set in communication control apparatus EQ-X.

It can be seen that based on the communication mechanism between network internal devices described above, communication between network internal devices can be controlled as desired, by appropriately manipulating the address of the ARP tables. Based on this concept, in the communication control method proposed by the present invention, communication control apparatus EQ-X generates and transmits an ARP packet, containing address information intentionally manipulated for communication control, such as communication cut-off or packet forwarding, of control object devices among network internal devices (EQ-1, EQ-2, EQ-3, . . . ). Let's assume that the communication rule is set to cut off communication between device EQ-1 and device EQ-2. In order to cut off communication between device EQ-1 and device EQ-2 according to the communication rule, communication control apparatus EQ-X manipulates the ARP addresses of the two devices. That is, communication control apparatus EQ-X manipulates the ARP address of device EQ-2 into N2-MX and provides it to device EQ-1, and at the same time, manipulates the ARP address of device EQ-1 into N1-MX and provides it to device EQ-2. The two devices, EQ-1 and EQ-2, receiving thus manipulated ARP addresses in a unicast method, reflect the manipulated addresses into their ARP tables, and communication after that time is based on the updated ARP table entries. This can be arranged as in the following table 6:

TABLE 6

| ARP table | EQ-1(N1-M1) | EQ-2(N2-M2) | EQ-3(N3-M3) |
|---|---|---|---|
| Normal state | N2-M2, | N1-M1, | N1-M1, |
| | N3-M3 | N3-M3 | N2-M2 |
| Manipulated | N2-MX, | N1-MX, | |
| state | N3-M3 | N3-M3 | |

According to this, each of the first device EQ-1 and the second device EQ-2 becomes to recognize communication control device EQ-X as if it is the counterpart side of communication, the second device EQ-2 and the first device, EQ-1 respectively. Accordingly, packets transmitted by the two devices EQ-1 and EQ-2 are transferred to communication control apparatus EQ-X whose MAC address is MX. That is, by manipulating the ARP table of related devices, packets transmitted by a predetermined device desiring to communicate with another device in the network can always be made to be transferred to communication control apparatus EQ-X (or a third address). It can be seen that if communication control apparatus EQ-X ignores the packet received from the two devices, communication between the two devices is cut off, and by doing so, the communication control apparatus can control communication between network internal devices regardless of the intentions of those devices.

Also, a case where the IP address of a device newly connected to a network collides with an IP address of an existing network internal device may take place and the communication control apparatus can automatically resolve this collision of IP addresses. That is, a new device, EQ-9, whose MAC address is MAC-9, broadcasts for communication with an IP address set as NET-1, this is detected by communication control apparatus EQ-X. Then, by referring the address of the new device EQ-9 to a communication control rule DB containing correct ‘IP address-MAC address’ information, it is determined whether or not the IP address of the new device is correct. If the determination result indicates that the IP address of the new device collides with the IP address of an existing device, a correct IP address is transferred to existing devices in a unicast method such that the collision of the IP address is resolved.

Furthermore, if a device is not an object of communication control any more but the communication control state of the device is still maintained, communication control apparatus EQ-X should allow the device to perform normal communication, by canceling the communication control state. For this cancellation, communication control apparatus EQ-X generates an ARP packet containing normal address information and transmits the packet to the device. In particular, the very important thing in the method for transmitting the ARP request packet is not broadcasting the packet, but unicasting the packet to the very devices requiring the packet such that desired entries (network layer addresses, data link layer addresses) can be maintained in the ARP table of the device receiving the unicast packet.

The method for setting a communication control rule can be performed in a variety of ways. A case where communication control apparatus EQ-X sets a rule for controlling communication between two network internal devices EQ-1 and EQ-2 will now be explained as an example.

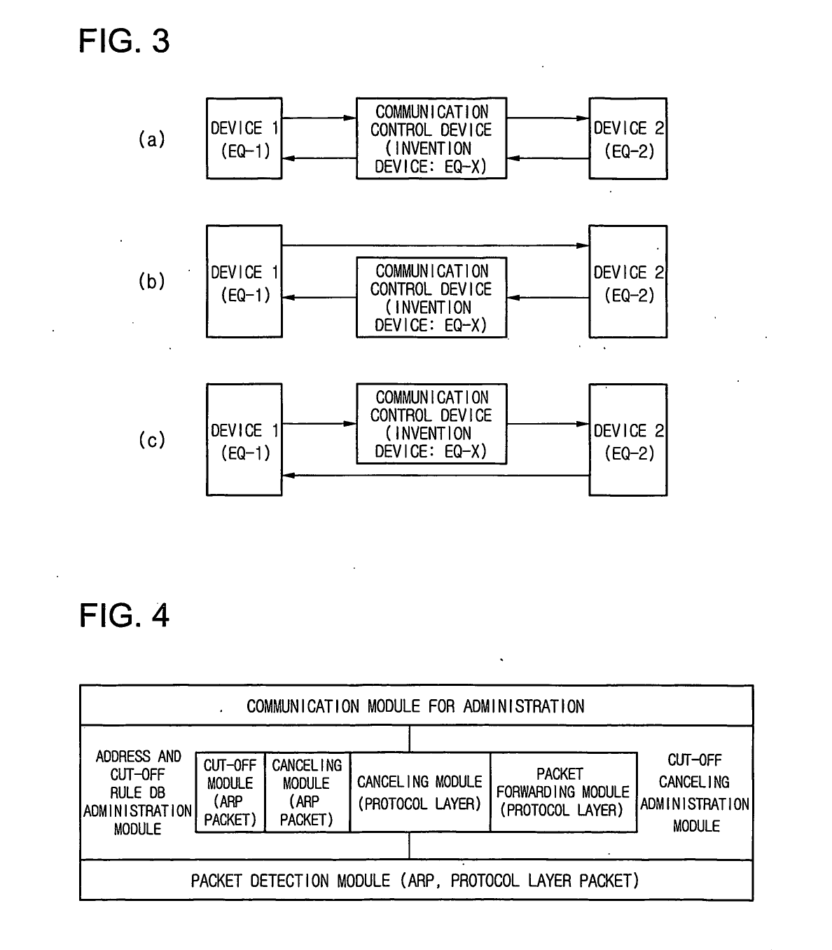

In a first method, as shown in FIG. 3A, a communication rule is set such that all packets intended to be transmitted to the other side by device EQ-1 and device EQ-2 are always received by communication control apparatus EQ-X, and by referring to communication rights between these two devices, communication control apparatus EQ-X permits or cut off the communication.

In a second method, as shown in FIG. 3B, a communication rule is set such that when device EQ-1 transmits a packet to device EQ-2, the packet is directly transmitted to device EQ-2 without passing through communication control apparatus EQ-X, but a packet intended to be transmitted to device EQ-1 by device EQ-2 is always transferred first to communication control apparatus EQ-X.

In a third method, as shown in FIG. 3C, oppositely to the second method, a communication rule is set such that a packet intended to be transmitted to device EQ-2 by device EQ-1 is always transferred first to communication control apparatus EQ-X, and packet intended to be transmitted to device EQ-1 by device EQ-2 is directly transferred to device EQ-1.

Communication control between network internal devices based on this concept can be implemented by software, and means for this include software and a computer (that is, communication control apparatus EQ-X) or the like in which the software can be installed and executed. Programs for implementing the present invention can be broadly broken down into three parts, that is, a server program, an agent program, and a client program. These three programs may be located all in an identical apparatus, that is, communication control apparatus EQ-X, or in different apparatuses. The agent program is the one that is actually responsible for controlling communication between predetermined devices by using communication control rules set through a server program and collected address data, and can be formed in a plurality of units. The server program is responsible for integrated administration of the plurality of agent programs, transfer of commands for agent programs from a user, and integrated administration data collected from agent programs. The client program is playing a role of an interface for a user, and can be a dedicated client program installed in an administrator computer, or a web program that can be used in a web browser.

In particular, the agent program has a function playing the core role for implementing communication control according to the present invention. This program can administer a plurality of networks by maintaining a plurality of Ethernet interfaces, and with employing a method using 802.1Q VLAN, also has a function capable of administering and controlling a plurality of networks by using one Ethernet interface. The agent program is formed with a plurality of modules having the structure as shown in FIG. 4. The types and major functions of modules forming the agent program are as shown in the following table 7:

TABLE 7

| Module type | Major function |
|---|---|
| Communication | Reception and transmission of collected data |
| module for | and events for administration of communication |
| administration | control rules through a server |
| Cut-off/canceling | Execute communication cut-off and cancel |
| administration | communication cut-off according to received |
| Module | packet or administrator's command |
| Cut-off module | Transmit ARP packets for communication cut-off, |
| | by using ARP packets |
| Canceling module | Transmit ARP packets for canceling communication |
| | cut-off state, by using ARP packets |
| Address and cut- | Administer various address and cut-off rule DBs |
| off rule DB | |
| administration | |
| module | |
| Packet cut-off | Transmit communication cut-off packet at protocol |
| module | layer |
| Packet forwarding | Forward packet requiring forwarding among |
| module | packets cut off by ARPs at protocol layer |
| Packet detection | Receive packets from network interface and |
| module | detects ARP packets from network card |

For faster processing, the agent program administers all DBs in the memory by using hash and data linked lists. The types of DBs administered are shown in the following table 8. The address and cut-off rule DB administration module administers these DBs.

TABLE 8

| DB name | Administration contents |
|---|---|
| Protocol address | Protocol addresses, whether or not to cut off, |
| DB (DB-1) | cut-off period, whether or not to fix |
| | (protocol address to a data link layer address) |
| Data link-MAC | Date link layer addresses, whether or not to |
| address DB (DB-2) | cut off, cut-off period, whether or not to |
| | fix (data link layer address to a protocol |
| | address) |
| Protocol-Data | Protocol/data link layer addresses, whether |
| link layer | or not to fix, recent activity times |
| address DB (DB-3) | |
| Protocol address | Protocol address group, whether or not to |
| group DB (DB-4) | communicate between in-group devices |
| Data link layer | Data link layer address group, whether or not |
| address group DB | to communicate between in-group devices |
| (DB-5) | |
| Per-Item rule | For protocol (data link) address of unit item, |
| DB (DB-6) | set and administer cut-off/forwarding rule |
| | with protocol (data link) address and protocol |
| | (data link) group |
| Between-group | Set and administer cut-off/forwarding rule |
| rule DB (DB-7) | between a protocol/data link layer address |
| | group and any other protocol/data link layer |
| | address group |
| Administration | Set a protocol address range to be administered |
| object setting | |
| DB (DB-8) | |

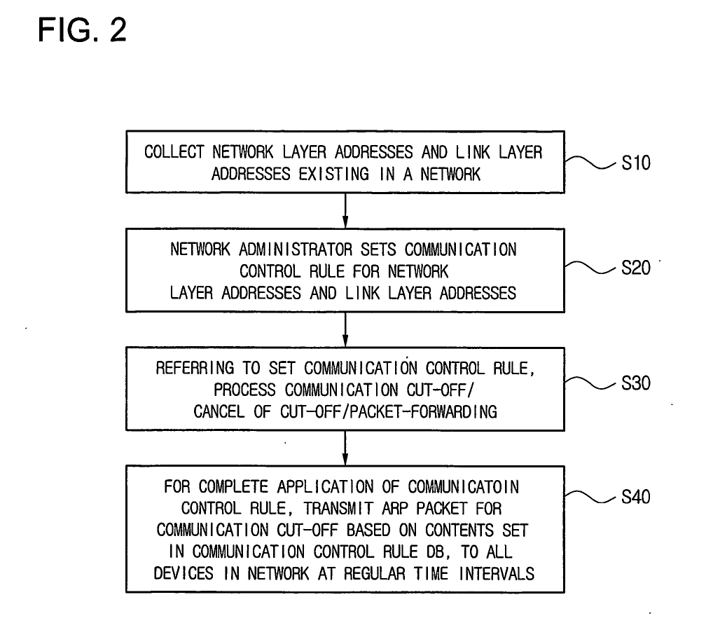

Next, FIG. 2 is a schematic flow chart of the steps performed by a method according to the present invention for controlling communication between network internal devices connected to a LAN.

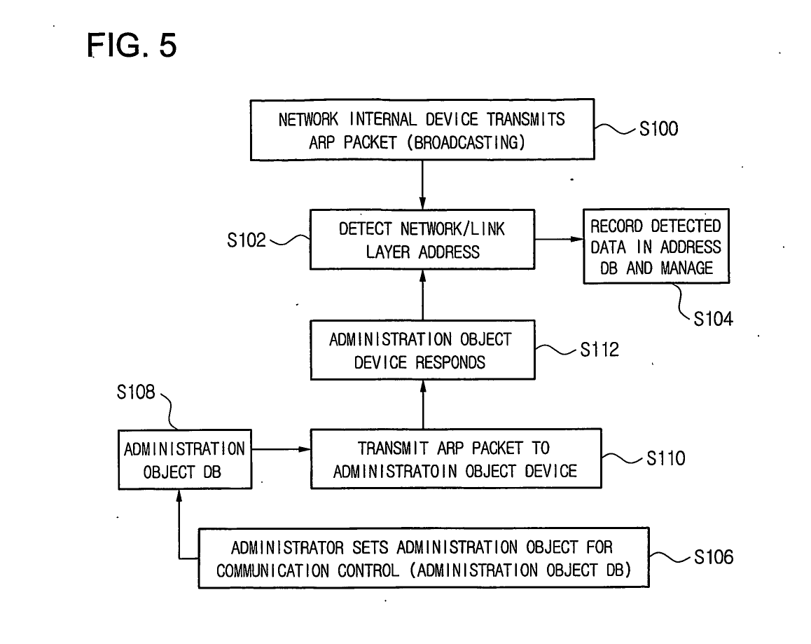

In order to control communication between network internal devices (EQ-1, EQ-2, . . . , EQ-10) connected to the LAN 40, a process that should be performed first is to collect network layer addresses and data link layer addresses existing in the LAN 40 in step S10. A leading example of a network layer address is an IP address and that of a data link layer address is a MAC address. FIG. 5 shows a detailed execution process of the address collecting step S10. Collecting addresses is performed in the following two exemplary methods.

One is a method that when a new device is added to the LAN 40 and desires to communicate with other devices in the network, the device broadcasts an ARP packet to request responses from other devices, and a communication control apparatus receives the ARP packet generated in that process, and collecting the address of the new device. More specifically, when a predetermined device in the LAN 40 broadcasts an ARP packet to communicate with any other network internal device in step S100, communication control apparatus EQ-X receives the ARP packet and detects the network layer address and data link layer address included in the ARP packet in step S102.

The other is a method in which if a network administrator directly inputs the address of an administration object device, the address is collected from the input. That is, if the network administrator sets an administration object for communication control in an administration object DB in step S106, the set contents are stored in the administration object DB in step S108. Then, the communication control apparatus transmits an ARP packet to the administration object device set in the administration object DB in a unicast method in step S110, and if the administration object device transmits an ARP packet in response to this in step S112, the communication control apparatus receives the ARP packet and detects the network layer address and data link layer address included in the ARP packet in step S102. In both methods, collected addresses are stored in an address DB and administered.

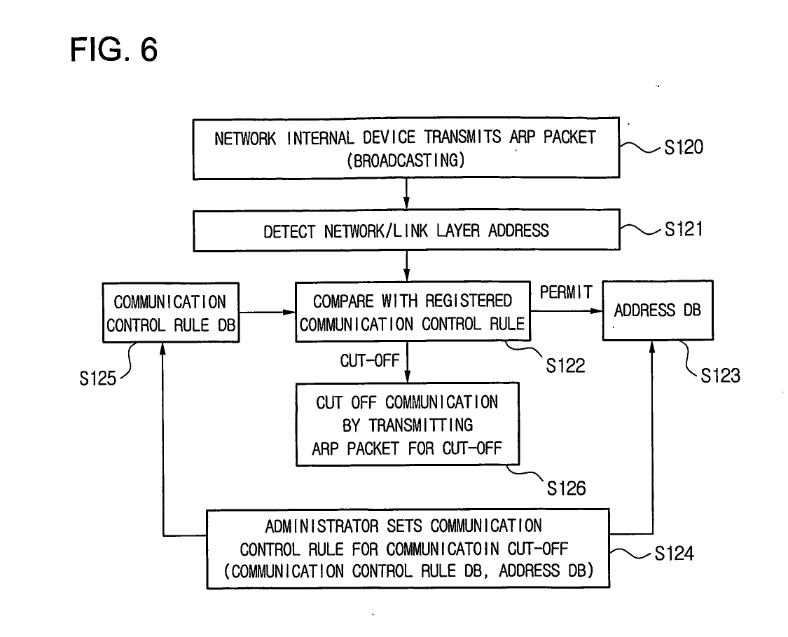

Next, based on the collected address, the network administrator sets a communication control rule for the network layer address and data link layer address in step S20. If the communication control rule is set, communication control apparatus EQ-X performs cutting off communication between network internal devices, canceling cut-off, or packet forwarding, according to the set communication control rule in step S30. This will now be explained in more detail with reference to FIG. 6 showing a process for setting a rule for cutting off communication and a cut-off process according to the rule.

Referring to FIG. 6, the network administrator can set a communication control rule for network internal devices whose communication should be controlled. Setting a communication control rule is performed according to the following steps.

(1) In the first step, a network layer address group, and a data link layer address group are generated based on data collected in relation to network layer addresses (Ethernet IP addresses) and data link layer addresses (MAC addresses) existing in the network, and manually input data. However, since the network layer address group and the data link layer address group are needed to be used only when administering address resources by the group of address resources having common attributes is convenient, this step is not an essential step that should be employed.

(2) In the second step, it is set whether or not communication of each of the network layer addresses, the data link layer addresses, the network layer address groups, and the data link layer address groups is utterly cut off from the source. That is, whether to permit or cut off communication from the source is set.

(3) In the third step, it is set whether communication of each of the entire network layer addresses with other network layer addresses, the data link layer addresses, the network layer address groups, and the data link layer address groups is permitted or cut off.

(4) In the fourth step, it is set whether communication of each of the entire data link layer addresses with the network layer addresses, the other data link layer addresses, the network layer address groups, and the data link layer address groups is permitted or cut off.

(5) In the fifth step, it is set whether or not communication of each group of the entire network layer address groups with other network layer address groups, and the data link layer address groups is cut off.

(6) In the sixth step, it is set whether or not communication of each group of the entire data link layer address groups with the network layer address groups, and other data link layer address groups is performed. As shown in FIG. 3, when a communication control rule is set, a direction in the packet routes can also be set.

Thus setting a communication control rule is performed in a method in which a network administrator manually inputs the rule by using communication control apparatus EQ-X. The input communication control rule is stored and administered in a communication control rule DB, and also, a time setting the communication control rule and other information are recorded in an address DB for the purpose of administration in steps S123 through S125. The objects for setting a communication control rule include communication between network layer addresses, communication between data link layer addresses, and communication between network layer addresses and data link layer addresses. Furthermore, when a group concept is introduced for network layer addresses and data link layer addresses, the objects for setting a communication control rule also include communication between network layer address and network layer address groups, communication between data link layer address and data link layer address groups, communication between network layer addresses and data link layer address groups, communication between data link layer addresses and network layer address groups, and communication between network layer address groups and data link layer address groups. The contents of communication control may include cut-off of communication, packet forwarding, canceling cut-off, permission, and so on. For example, it is assumed that the network layer address and the data link layer address of network internal devices are NET-i (here, i=0, 1, 2, . . . ) and MAC-j (here, j=0, 1, 2, . . . ), respectively. There is a case where according to necessity of, for example, administration of network internal devices, a plurality of network layer addresses or a plurality of data link layer addresses are made to form a group and administered as a group.

Thus, when a group concept is introduced for addresses are administered in units of groups, it is assumed that network layer address groups and data link layer address groups are referred to as NETG-m (here, m=0, 1, 2, . . . ) and MACG-n (here, n=0, 1, 2, . . . ), respectively. Since address groups are generated considering the necessity of administration or convenience, an address of a predetermined device may be included in a plurality of groups, or may not be included in any group. For example, a communication control rule for a device whose network layer address is NET-1 can be set as the following table 9. Communication control rules for other network layer addresses, data link layer addresses, and each group of these addresses can also be set in the same manner.

TABLE 9

| Administration | Communication | Communication |
|---|---|---|
| object address | partner address | control rule |
| NET-1 | NET-2 | Cut off |
| NET-1 | NET-3 | Permit |
| NET-1 | NET-4 | Permit |
| NET-1 | NET-5 | Forwarding |
| . . . | . . . | . . . |
| NET-1 | NETG-1 | Cut off |
| NET-1 | NETG-2 | Permit |
| . . . | . . . | . . . |
| NET-1 | MAC-1 | Permit |
| NET-1 | MAC-2 | Cut off |
| NET-1 | MAC-3 | Forwarding |
| . . . | . . . | . . . |
| NET-1 | MACG-1 | Cut off |
| NET-1 | MACG-2 | Permit |
| . . . | . . . | . . . |

Through the processes described above, if addresses of network internal addresses are collected and communication control rules for the collected addresses are set, it means that a condition for controlling communication between network internal devices based on the set communication rules has been prepared. Under this condition, if predetermined device EQ-i in the network broadcasts an ARP packet in order to communicate with any other network internal device EQ-j in step S120, communication control apparatus EQ-X also receives the ARP packet, and detects the network layer address and data link layer address included in the ARP packet. Communication control apparatus EQ-X compares detected addresses with information registered in advance in a communication control rule DB and determines whether or not detected addresses are the objects of communication cut-off. If the detected addresses are determined as the object of communication cut-off, the communication control apparatus transmits an ARP packet manipulated for communication cut-off to all network internal devices in a unicast method. In the manipulated ARP packet, not the MAC addresses of EQ-i and EQ-j that are the subjects of the communication, but the MAC address of communication control apparatus EQ-X or a third device is set. As a result, a packet desired to be transmitted between device EQ-i and device EQ-j is first transferred to communication control apparatus EQ-X (or the third device) and is processed to be ignored and not to be transferred to the other side of the communication, and by doing so, communication between the two devices can be cut off.

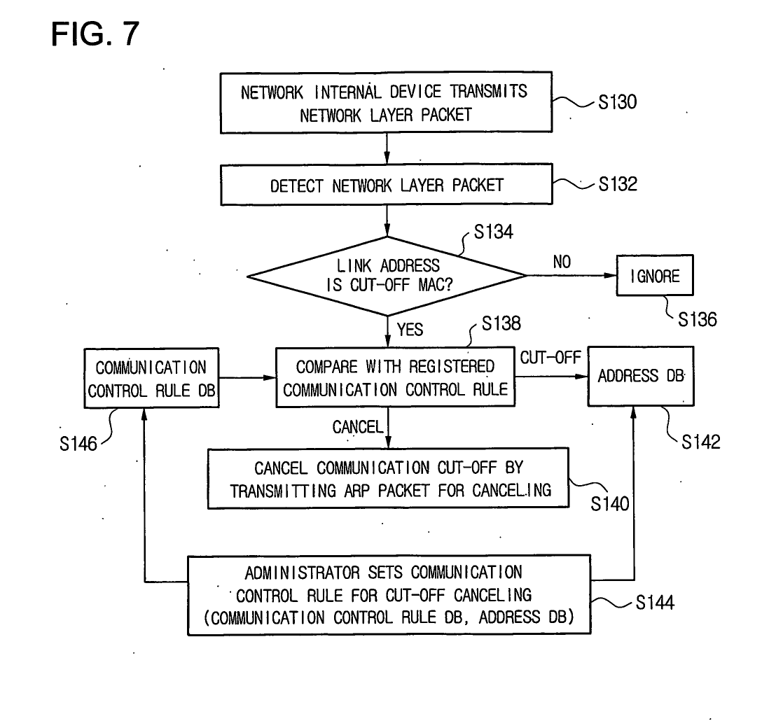

It may be needed to guarantee free communication for a predetermined address that has been treated as the object of communication cut-off, after a predetermined time by a predetermined reason. In this case, a network administrator can reset a rule set for communication cut-off and in responsive to this, the state of communication cut-off for the object needs to be canceled. This process is shown in FIG. 7. The administrator sets a rule to cancel communication cut-off by using the communication control apparatus (EQ-X). The set canceling rule is also recorded in the communication control rule DB and a time setting the canceling rule and other information are recorded in an address DB for the purpose of administration in steps S144, S142, and S146.

Meanwhile, if predetermined device EQ-i in a network broadcasts a network layer packet (for example, an IP packet) in order to communicate with another device EQ-j in step S130, communication control apparatus EQ-X receives the packet and detects the included network layer packet in step S132. For reference, cancellation of communication cut-off is performed always by using a layer-3 (L3) packet. Then, since canceling communication cut-off is needed only when an address is the object of communication cut-off, it is determined whether or not a data link layer address included in the detected packet is a cut-off MAC in step S134. Here, the cut-off MAC means a MAC address intentionally manipulated by communication control apparatus EQ-X for communication cut-off. If it is not a cut-off MAC, the address is not in a state of communication cut-off, and accordingly, there is no need of cancellation, and the address is just ignored in step S136. However, if it is a cut-off MAC, the address is currently in a state of communication cut-off, communication control apparatus EQ-X refers the data link layer address to the communication control rule DB and compares it with registered communication control rules in step S138. If the comparison result confirms that the address is still the object of communication cut-off, the state is needed to be maintained without change, and the detection time is updated in the address DB for the purpose of administering the network in step S142. However, if the comparison result indicates that the set communication control rule is the object of canceling communication cut-off, the communication control apparatus transmits an ARP packet for canceling to all network internal devices in the network in a unicast method such that the communication cut-off state is canceled in step S140. In the ARP packet transmitted for canceling the communication cut-off, a normal MAC address is included and since that time, network internal devices having received the ARP become to be able to normally communicate with the device having the MAC address. By doing so, the communication cut-off state is canceled.

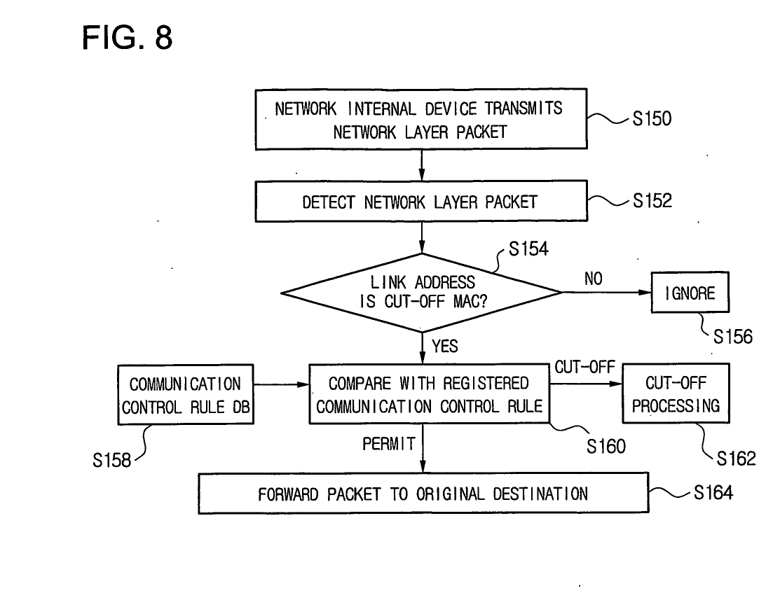

FIG. 8 shows a process for processing communication control between network internal devices according to a rule set in a communication control rule DB. If predetermined device EQ-i in a network broadcasts a network layer packet in order to communicate with other devices in the network in step S150, the communication control apparatus detects the network layer packet in step S152, and determines whether or not the data link layer address included in the packet is a cut-off MAC in step S154. If it is not a cut-off MAC, the address is not the object of communication cut-off and therefore is just ignored in step S156. Then, normal communication between the device having the data link layer address and device EQ-i requesting the communication will be performed. However, if the data link layer address is a cut-off MAC, it means the address is the object of communication cut-off, and the communication control apparatus compares the address with communication control rules registered in a data link communication control rule DB in steps S158 and S160 and determines which control is performed. If the address is set as an object of communication cut-off, transmission of a manipulated ARP packet is performed as described above such that communication can be cut off. If the address is set as an object of communication permission, the network layer packet is forwarded to the original destination in step S164.

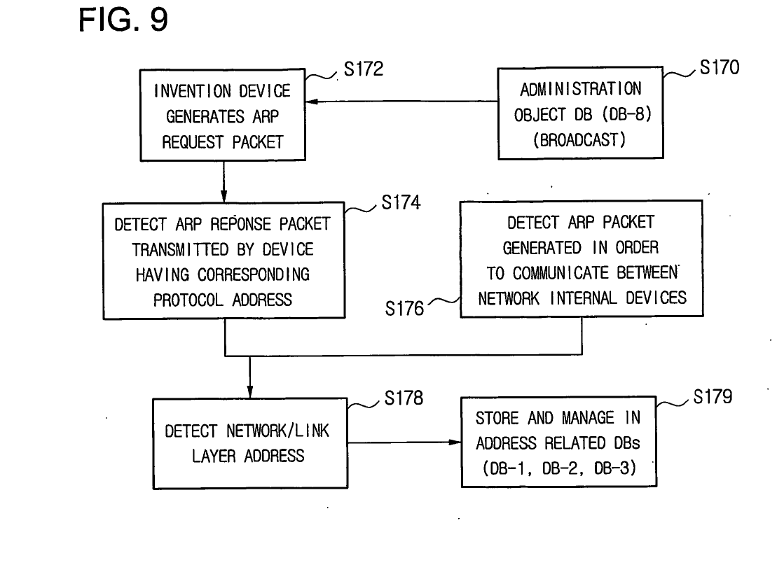

FIG. 9 is a flow chart showing details of a process for detecting a packet and collecting an address according to the detection. Routes for collecting network layer addresses and data link layer addresses are broadly broken down into two types. In one type as shown in FIG. 19, communication control apparatus EQ-X broadcasts an ARP request packet by referring to addresses in an administration object DB in steps S170 and S172, and if a network internal device having a protocol address included in the transmitted ARP request packet responds with an ARP reply packet, collects the address from the reply packet in steps S174 and S178. In the other method, without this request process, an ARP packet is broadcast on the network in order for network internal devices to communicate with each other, and the communication control apparatus receives thus generated ARP packets and detects an address from the received ARP packet in step S176 and S178. The detected address is stored and administered in an address related DB without change and at this time, the detection time is stored together for the purpose of administration.

Next, processing for the cut-off/cancellation administration module of an agent program includes: communication control processing following detection of a packet; processing following detection of an ARP request packet; processing following detection of an ARP reply packet; processing following detection of a protocol layer; retrieval of administration rules by protocol address and data link layer addresses; and retrieval of administration rules by a protocol address. This will now be explained in more detail.

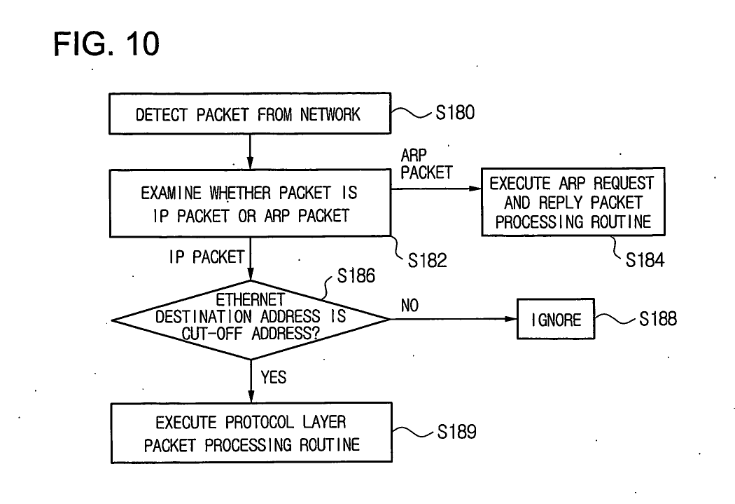

A process for processing communication control according to a detected packet is shown in FIG. 10. Depending on whether the detected packet is an IP packet or an ARP packet, the following process is determined differently. If communication control apparatus EQ-X detects a packet in a network in any route in step S180, it is examined whether the detected packet is an IP packet or an ARP packet in step S182. If it is an ARP packet, a routine following detection of an ARP request packet and a routine following detection of an ARP reply packet are executed in step S184. If it is an IP packet, it is also examined whether or not the Ethernet destination of the packet is a cut-off address in step S186. A cut-off address is an address manipulated by the communication control apparatus. Accordingly, if the address is not a cut-off address, normal communication needs to be guaranteed, and the communication control apparatus does not perform any action and just ignores it in step S188. If the address is a cut-off address, the communication control apparatus should perform processing for communication cut-off. For this, the routine for processing a protocol layer packet is performed such that any one of a canceling module and a packet forwarding module is performed in step S189.

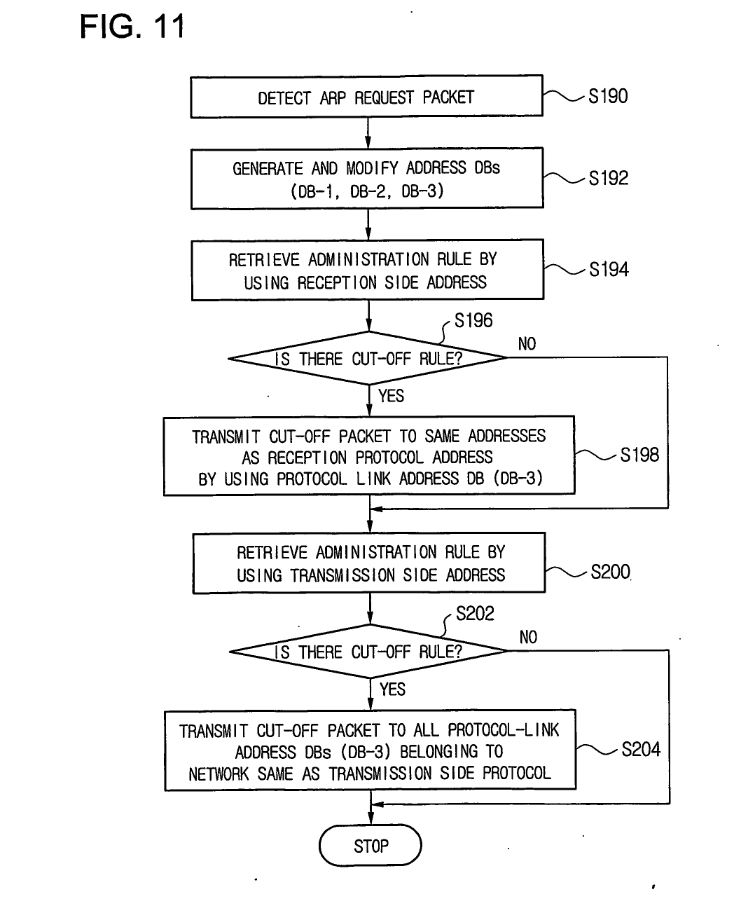

FIG. 11 is a detailed flow chart of a ‘processing routine following detection of an ARP request packet’ in step S184 of FIG. 10. The ARP request packet is generally transmitted in a broadcasting method. If a predetermined network internal device broadcasts an ARP request packet in order to communicate with any other device, communication control apparatus EQ-X detects the ARP request packet in step S190. The address included in the detected ARP request packet is extracted and is reflected in address DBs such as a protocol address DB (DB-1), a data link-MAC address DB (DB-2), and a protocol-data link layer address DB (DB-3), by newly generating or modifying the addresses in step S192. Then, processing for communication cut-off is performed with a reception side address in the first detected addresses in step S194, S196, and S198. For this, first, the communication control apparatus uses the reception side address to check whether there is an administration rule for the address in step S194. If the reception side address is the object of communication cut-off, that is, if there is a cut-off for the address, the communication control apparatus uses the protocol-data link layer address DB (DB-3) to perform transmission of a cut-off packet to ‘the same address’ as the reception side protocol address in step S198. For example, if the reception side protocol addresses are NET-1 and NET-3, the communication control apparatus transmits the cut-off packets to devices EQ-1 and EQ-3 having the same protocol addresses. For example, assuming that NET-3 is the object of cut-off, when device EQ-1 desire to communicate with device EQ-3, the communication control apparatus receives an ARP request packet broadcast by device EQ-1, and in this case, the communication control apparatus transmits ARP packets to EQ-1 and EQ-3. According to the transmitted ARP packets, false address information is provided to EQ-1 such that EQ-3 is recognized as if EQ-3 is the communication control apparatus, and another false address information is provided to EQ-3 such that EQ-1 is recognized as if EQ-1 is the communication control apparatus. According to this, packets transmitted by devices EQ-1 and EQ-3 are transferred to communication control apparatus EQ-X and ignored, and communication between the two devices is cut off. After the processing using the reception side address is finished, communication cut-off with the transmission side address is also performed in steps S200, S202, and S204. This processing is quite similar to the processing with the reception side address, but there is only one difference that the recipients of a cut-off packet are ‘all’ protocol-data link layer address DB (DB-3) belonging to the same network as the transmission side protocol, because the ARP request packet broadcast by the transmission side affects all network internal devices.

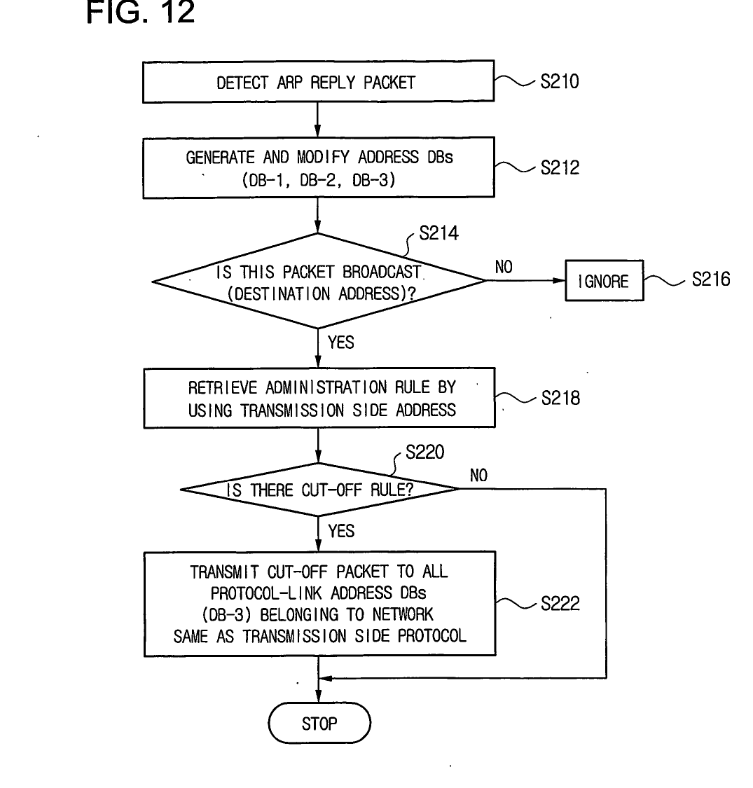

FIG. 12 shows a ‘processing routine following detection of an ARP reply packet’ in step S184 of FIG. 10. If a network internal device transmits an ARP reply packet in response to an ARP request packet transmitted by the communication control apparatus, the communication control apparatus detects the packet in step S210, extracts an address included in the packet, and reflects it into address DBs such as the protocol address DB (DB-1), the data link-MAC address DB (DB-2), and the protocol-data link layer address DB (DB-3). The ARP reply packet is generally transmitted in a unicasting method. Accordingly, if the detected reply packet is a packet transmitted in a unicasting method, the packet is a normal one, and only the following processing prepared for the packet by the communication control apparatus is performed in steps S214 and S216. However, if the reply packet is a packet transmitted in a broadcasting method, it means that the packet that should not be transferred to other network internal devices is abnormally transferred, and accordingly, an appropriate following process is needed. That is, by using the transmission side address included in the detected reply packet, an administration rule is retrieved in step S218, and if the retrieval result indicates that there is a cut-off rule for the transmission side address, transmission of cut-off packets to all protocol-data link layer address DBs (DB-3) belonging to the same network as the transmission side protocol is performed in steps S220 and S222. This is because the reply packet is broadcast, all the network internal devices are affected by the packet, and communication based on the packet can take place. Accordingly, in this case, communication between objects of communication cut-off should be cut off.

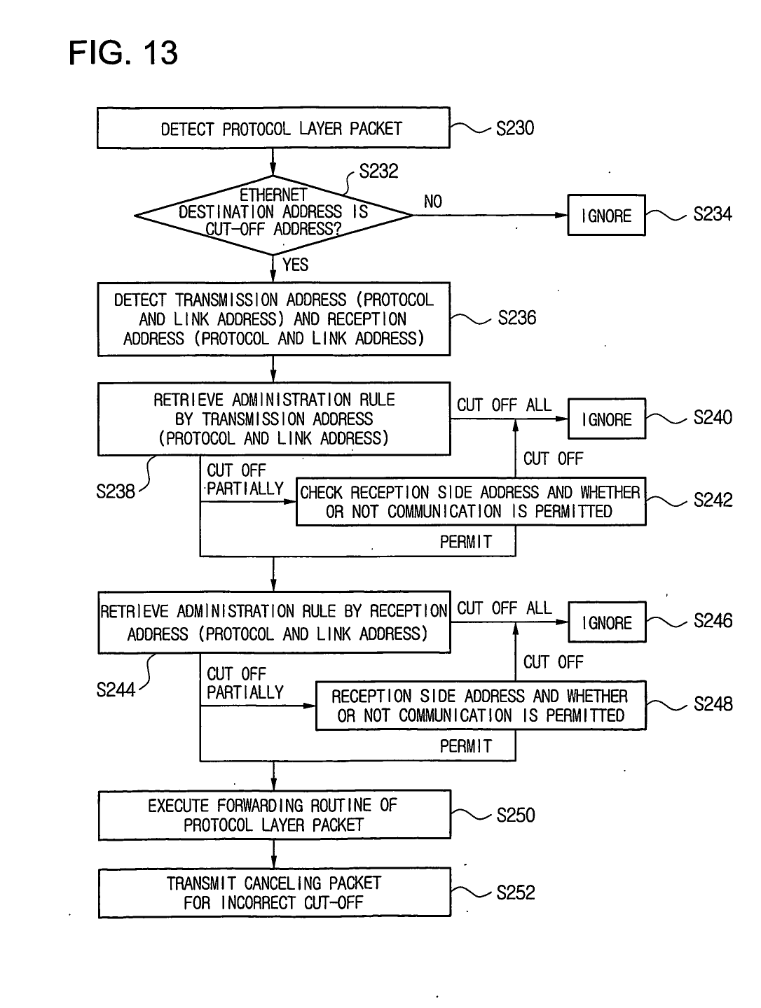

FIG. 13 is a flow chart of a process following detection of a protocol layer packet. This corresponds to the step S189 of FIG. 10. If the communication control apparatus detects a protocol layer packet in step S230, it is checked whether or not the Ethernet destination address included in the packet is a cut-off address in step S232. The process to be performed next by the communication control apparatus according to the result of the checking includes canceling communication cut-off, forwarding the packet, and ignoring the packet. If the Ethernet destination address is not a cut-off address, normal communication should be guaranteed and therefore the packet is just ignored in step S234. If the Ethernet destination address is a cut-off address, it corresponds to a case where the communication control apparatus provides in advance a manipulated MAC address, that is, a packet whose MAC address is set as that of the communication control apparatus, to the corresponding device such that communication with the device is cut off. In this case, the transmission side address (protocol and data link layer addresses) and the reception side address (protocol and data link layer addresses) are detected in step S236, and according to the transmission side address and the reception side address, processing, such as permitting communication, cutting off communication, or forwarding the packet, is performed. First, the communication control apparatus retrieves an administration rule according to the transmission side address in step S238, and if it is set as all cut-off, the communication control apparatus just ignores the packet in step S240. Then, the packet cannot move beyond the communication control apparatus such that communication is cut off from the source. If the administration rule according to the transmission side address is partial cut-off, it is checked whether or not communication with the reception side address is possible in step S242. If it is set as cut-off, the packet is ignored in step S240, and if the communication is permitted, an administration rule is retrieved according to the reception side address in step S244. In the same manner, if the retrieval result indicates all cut-off, the packet is just ignored in step S246, and if the retrieval result indicates partial cut-off, it is checked whether or not communication with the transmission side address is permitted in step S248. If communication is cut off, the packet is just ignored. If communication is permitted, the forwarding routine for the protocol layer packet is performed in step S250. Then, if the communication cut-off is incorrect, a packet for canceling the communication cut-off state is transmitted, and by doing so, a process for correcting the incorrect state is performed in step S253. By this canceling process, the protocol layer packet is not transmitted to the communication control apparatus any more and is transmitted to a normal destination.

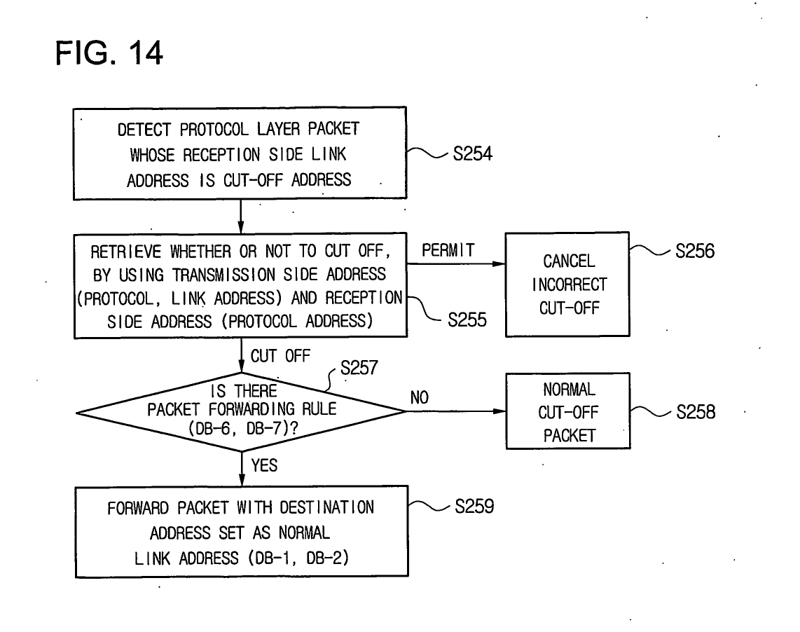

FIG. 14 shows the packet forwarding step S250 of FIG. 13. In the packet forwarding process, if the communication control apparatus detects a protocol layer packet in which the reception side data link layer address is a cut-off address in step S254, it is retrieved whether or not communication is cut off by the transmission side address and the reception side address. If the retrieval result indicates that the addresses are not set as communication cut-off addresses, the current state in which communication is cut off is incorrect, and accordingly, a process for canceling the communication cut-off is performed in step S256. If the retrieval result indicates that communication cut-off is set, it is also checked whether the packet is cut off or forwarded in step S257. If there is a packet forwarding rule for the detected address, the packet is forwarded with the destination address of the packet as a normal data link layer address in step S259. If there is no forwarding rule, the packet should be normally cut off, and accordingly, is not transferred to any other devices and is just ignored in step S258.

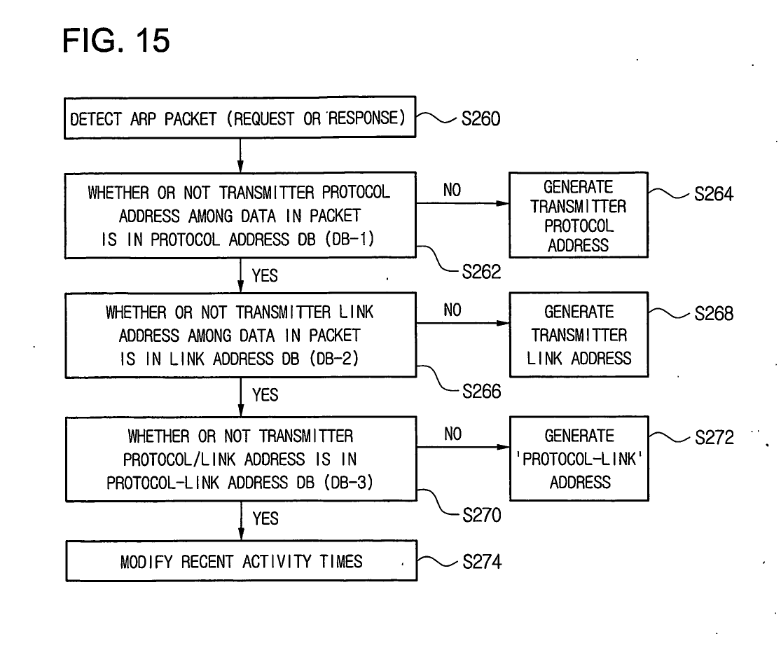

Next, an address DB administration step (for example, step S192 of FIG. 11 and step S212 of FIG. 12) following detection of an ARP reply packet and an ARP request packet will now be explained with reference to FIG. 15. The reason for administering the address DB is that in order to administer network internal devices, and to control communication in particular, a list of network internal devices that are the objects of administration and control should be secured, and the list of devices currently turned on and running normally should be identified in particular. If the communication control apparatus detects an ARP request packet or an ARP reply packet transmitted by any network internal device in step S260, it is checked whether or not the transmitter protocol address included in the data in the detected packet is in the protocol address DB (DB-1) in step S262. If the address is not in DB-1, it means that the address is a new one, and the transmitter protocol address is generated in step S264. If the address is in DB-1, as a next step it is checked whether or not the transmitter data link layer address in the data of the packet is in the data link layer address DB (DB-2) in the next step S266. If the address is not in DB-2, the transmitter data link layer address is generated in the same manner in step S268, and if the address is in DB-2, it is checked whether or not a combination of a pair of the transmitter protocol address-transmitter data link layer address is in the protocol-data link layer address DB (DB-3). If the combination is not in DB-3, the protocol-data link layer address combination is generated in step S272, and if it is in DB-3, the addresses are not needed to be generated newly. However, for the purpose of smooth administration of devices on the network, the communication control apparatus records the time receiving the packet from the device in the address administration DB such that the recent activity times of the device can be shown.

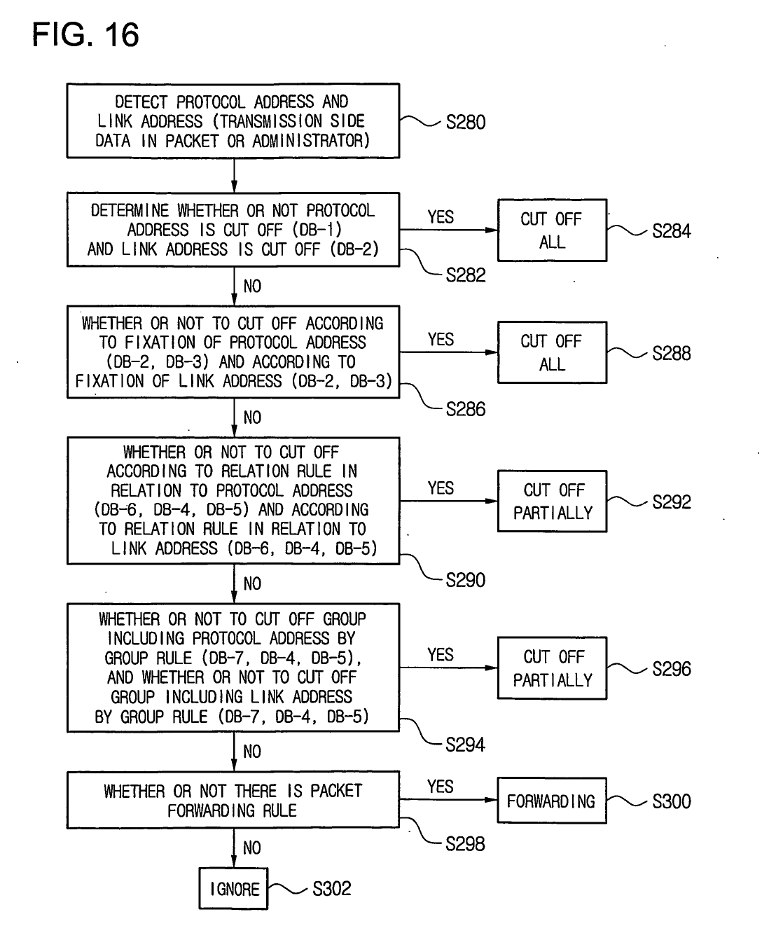

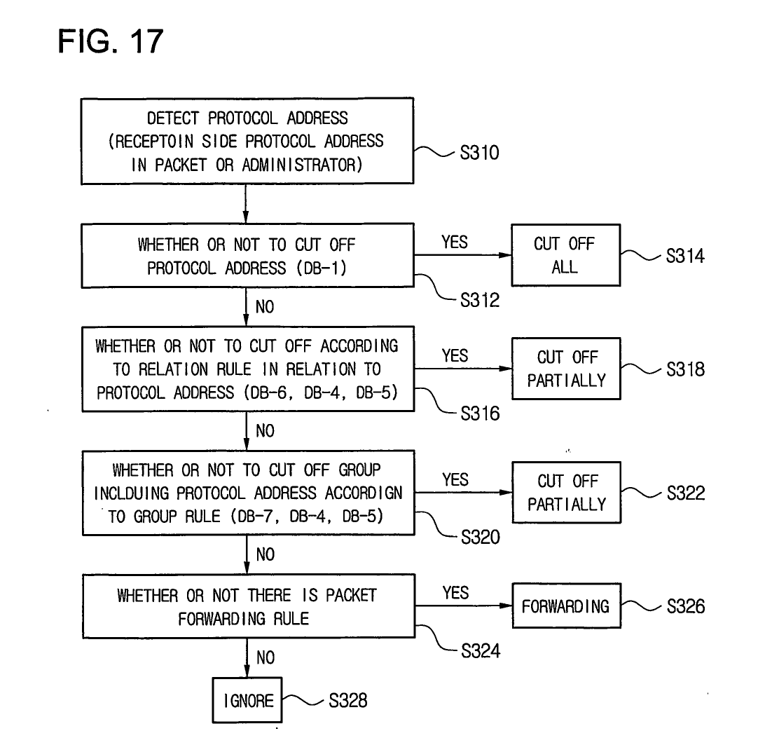

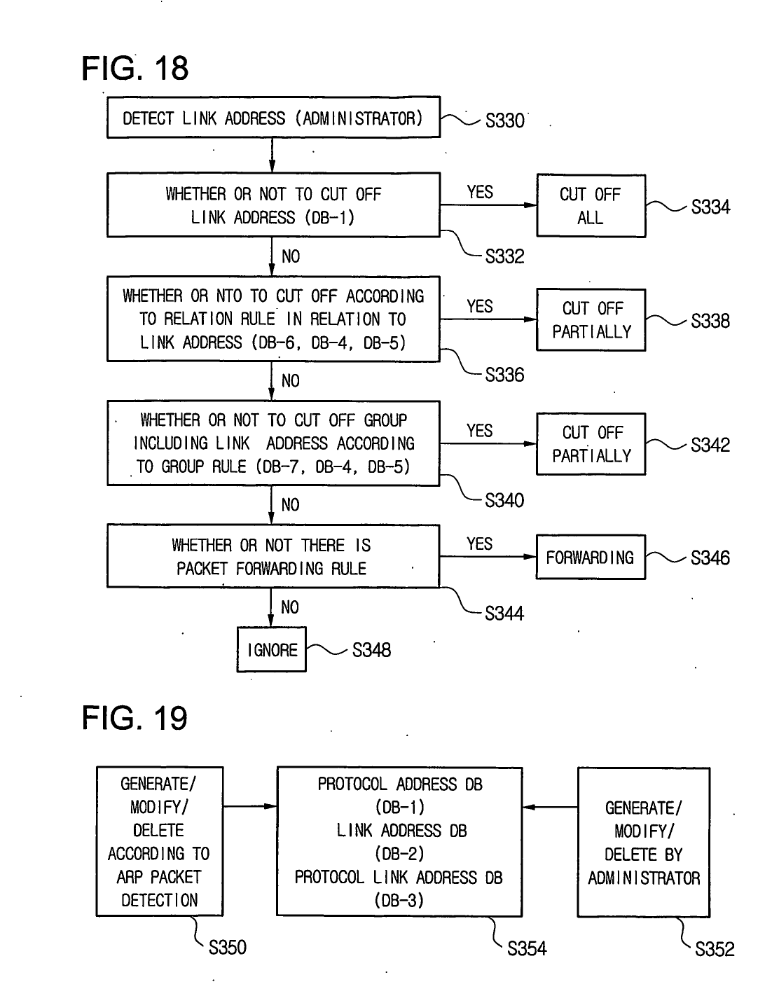

Next, the network administrator can set a communication control rule for a protocol address or a data link layer address individually, and can also set a communication control rule for the combination of the two addresses. FIG. 16 shows a process for retrieving and processing a communication control rule set for a combination of a protocol address and a data link layer address, and FIGS. 17 and 18 show processes for retrieving and processing a communication control rule according to a protocol address and a data link layer address.

In the flow chart of FIG. 16, first, the communication control apparatus detects a protocol address and a data link layer address from transmission side data in a packet or data manually input by the administrator in step S280. After address detection is thus performed, the following processes are performed.

(1) Inquiring whether or not the detected protocol address and data link layer address themselves are the objects of cut-off, by referring to the protocol address DB (DB-1) and the data link-MAC address DB (DB-2) in step S282

(2) Inquiring whether or not communication of the detected protocol address with a set of other addresses, and communication of the detected data link layer address with a set of other addresses are the objects of communication cut-off, by referring to the data link-MAC address DB (DB-2) and the protocol-data link layer address DB (DB-3) in step S286

(3) Inquiring whether or not each of the detected protocol address and data link layer address is the object of communication cut-off by a relation rule, by referring to the protocol address group DB (DB-4), the data link layer address group DB (DB-5) and per-item rule DB (DB-6) in step S290

(4) Inquiring whether or not the group including the detected protocol address and the group including the detected data link layer address are the objects of communication cut-off by a group rule, by referring to the protocol address group DB (DB-4), the data link layer address group DB (DB-5) and between-group rule DB (DB-7) in step S294

(5) Inquiring whether or not there is a packet forwarding rule for the detected packet in step S298.

If the result of the inquiring confirms that the addresses are confirmed as an object of cut-off, processing for communication cut-off is performed. At this time, in cases of steps S282 and S286, full-scale communication cut-off for the addresses should be performed in steps S284 and S288. However, in cases of steps S290 and S294, communication cut-off is performed not for the entire relations or the entire group, but for corresponding addresses among those of the entire relations or the entire group in steps S292 and S296. If there is a forwarding rule for the detected packet, the packet is forwarded in step S300, and otherwise, the packet is just ignored in step S302.

The processing of the communication control rule according to a protocol address shown in FIG. 17 will now be explained. The communication control apparatus detects the reception side protocol address in a received packet, or a protocol address from data manually input by the administrator in step S310, and inquires whether or not the detected protocol address is an object of cut-off, by referring to the protocol address DB (DB-1) in step S312. If the address is the object of cut-off, communication with the protocol address is completely cut off in step S314, or else, whether or not the detected protocol address is cut off by an relation rule related to the detected address is inquired by referring to the protocol address group DB (DB-4), the data link layer address group DB (DB-5) and a per-item rule DB (DB-6) in step S316. If the inquiring result indicates that the relation rule is an object of cut-off, communication with those related to the detected protocol address is limitedly cut off in step S318. In addition, whether or not the group including the detected protocol address is cut off by the group is inquired by referring to the protocol address group DB (DB-4), the data link layer address group DB (DB-5), a between-group rule DB (DB-7) in step S320. If the inquiring result indicates that the group rule is an object of cut-off, communication with those related to the detected protocol address is limitedly cut off in step S322. Also, if there is a forwarding rule for the detected packet, the packet is forwarded in step S326, or else, is just ignored in step S328.

Processing a communication control rule by a data link layer address is performed in a similar manner, and can be easily understood with reference to the flow chart of FIG. 18. Accordingly, the explanation will be omitted.

### INDUSTRIAL APPLICABILITY

As described above, the present invention can be implemented as resource administration software of a network. Also, the software can be installed in a general purpose computer system or a communication control device manufactured for a dedicated purpose and can be used as the communication control apparatus described above.

Meanwhile, though the example of the LAN is explained above, the present invention can obviously be applied to any other kinds of networks.

The present invention enables efficient and uniform administration of huge network resources with limited human resources in a network environment becoming more complicated and diversified. Furthermore, the permitted scope of access to other devices in a predetermined network is set in advance for each user of devices in the network such that communication can be controlled to be available only within a permitted access range.

More specifically, the effects of the present invention include the following advantages.

First, more efficient operation of a network is enabled. That is, information on network resources can be automatically collected, and information on the occurrence of failure can be monitored in real time such that quick measures for the failure can be provided. Also, by selectively controlling internal/external communication data packets on the network, the network resources responsible for external networks can be saved, and reduction of a firewall server can increase the communication speed with any external network. In addition, a means capable of efficiently operating networks, for example, selectively imposing a desired permission of use on an individual network, can be secured.

Secondly, the internal security of a network can be strengthened. That is, in addition to limiting access to the network from an external network, access between internal networks can be limited and access to a predetermined server can also be limited. Accordingly, in addition to capability of communication control between network internal devices, which cannot be processed in a general firewall server, the IP address of a predetermined server can be protected, and leakage of information between illegal internal users, hacking, and cracking can be prevented, which can lead reduction of data packets.

Thirdly, stable operation of a network can be achieved. By collecting information on devices or resources in the network and monitoring, collecting and analyzing information on the state of the network, a failure can be warned before it takes place, or elements of failure can be removed in advance, and furthermore, when a failure occurs, identification of the reasons and measure to repair can be quickly provided.

Fourthly, IP collision can be effectively resolved. Since an IP address can also be manipulated in addition to a MAC address, when collision of an IP address between network internal devices takes place, a correct IP address is provided to the corresponding device such that the collision of the IP address can be automatically resolved.

Optimum embodiments have been explained above. However, it is apparent that variations and modifications by those skilled in the art can be effected within the spirit and scope of the present invention defined in the appended claims. Therefore, all variations and modifications equivalent to the appended claims are within the scope of the present invention.

What is claimed is:

1. A communication control method for controlling communication between devices on a predetermined network by using a communication control apparatus located on the same level as other devices of the network, the method comprising:
determining at least a cut-off object device of which communication is needed to be cut-off, according to a set communication control rule; and
providing an address resolution protocol (ARP) packet in which a data link layer address is manipulated, to the cut-off object device,
wherein the cut-off object device is controlled to transmit its data packets to manipulated abnormal addresses, and by doing so, communication by the cut-off object device is cut off.

2. The communication control method of claim 1, further comprising: transmitting an ARP packet including normal address information to a device which is in a communication cut-off state although the device is not an object of communication cut-off any more, such that the communication cut-off state is canceled.

3. The communication control method of claim 1, further comprising: setting part or all of the data link layer addresses of the cut-off object devices to the data link layer address of the communication control apparatus or a third data link layer address that is not of the cut-off object devices, such that communication between cut-off object devices is cut off.

4. The communication control method of claim 1, further comprising: if there is collision between the Internet protocol (IP) address of a device newly connected to the predetermined network and the IP addresses of existing devices, transferring a correct IP address to the existing devices in a unicast method such that the collision of the IP address is prevented.

5. The communication control method of claim 1, further comprising: collecting network layer addresses and data link layer addresses of network internal devices for which the communication control rule is set.

6. The communication control method of claim 5, wherein the step of collecting address is performed by a first method in which the communication control apparatus receives an ARP packet broadcast by a device in the network in order to communicate with any other device in the network, and detects a network layer address and a data link layer address included in the packet, and/or by a second method in which based on the address of an administration object device which is manually input by a network administrator, the communication control apparatus transmits an ARP request packet and detects a network layer address and a data link layer address from an ARP reply packet transmitted by the administration object device in response to the ARP request packet.

7. A communication control method for controlling communication between devices on a predetermined network, the method comprising:
collecting network layer addresses and data link layer addresses existing in the network, by a communication control apparatus;
storing communication control rules, which are set to perform desired communication control for collected addresses by a network administrator, in a communication control rule database (DB);
detecting an address resolution protocol (ARP) packet transmitted by a device in the network in order to communicate with another device in the network;
determining whether or not the detected ARP packet corresponds to a communication cut-off object, by referring to the communication control rule DB; and
if the packet corresponds to the communication cutoff object, transmitting an ARP for communication cut-off, wherein communication between network internal devices can be selectively controlled when necessary.

8. The communication control method of claim 7, wherein collecting the addresses is performed by a first method in which the communication control apparatus receives an ARP packet broadcast by a device in the network in order to communicate with any other device in the network, and detects a network layer address and a data link layer address included in the packet, and/or by a second method in which based on the address of an administration object device which is manually input by a network administrator, the communication control apparatus transmits an ARP request packet and detects a network layer address and a data link layer address from an ARP reply packet transmitted by the administration object device in response to the ARP request packet.

9. The communication control method of claim 7, wherein the objects of setting the communication control rule include communication between network layer addresses, communication between data link layer addresses, and communication between a network layer address and a data link layer address.

10. The communication control method of claim 7, wherein the objects of setting the communication control rule further include communication between network layer address and network layer address groups, communication between data link layer address and data link layer address groups, communication between network layer addresses and data link layer address groups, communication between data link layer addresses and network layer address groups, and communication between network layer address groups and data link layer address groups.

11. The communication control method of claim 7, wherein when a reception side address is an object of cut-off, a cut-off packet is transmitted to the ‘same addresses’ as the reception protocol address.

12. The communication control method of claim 7, wherein when a transmission side address is an object of cut-off, a cut-off packet is transmitted to ‘all’ protocol-data link layer addresses belonging to the same network as that of the transmission side protocol.

13. The communication control method of claim 7, further comprising: if a network internal device transmits an ARP reply packet in response to the ARP request packet transmitted by the communication control apparatus, retrieving an relation rule by using a transmission side address included in the detected reply packet, and if the retrieval result indicates that there is a cut-off rule for the transmission side address, transmitting a cut-off packet to all protocol-data link layer address DBs (DB-3) belonging to the same network as that of the transmission side protocol.

14. The communication control method of claim 7, further comprising: for a device which is in a communication cut-off state although the device is not an object of communication cut-off any more with detection of a network layer packet, transmitting an ARP packet for canceling the communication cut-off state.

15. The communication control method of any one of claims 7 and 14, further comprising: by referring to the communication control rule DB at regular time interval, transmitting an ARP request packet for communication cut-off/canceling communication cut-off according to a communication control rule registered in the DB.

16. The communication control method of claim 7, further comprising: if a reception side data link layer address is a cut-off address and there is a packet forwarding rule for the address, forwarding the received protocol layer packet with having the destination address of the received protocol layer packet as a normal data link layer address.

17. The communication control method of claim 7, further comprising: if there is collision between the Internet protocol (IP) address of a device newly connected to the predetermined network and the IP addresses of existing devices, transferring a correct IP address to the existing devices in a unicast method such that the collision of the IP address is prevented.

18. A communication control apparatus which is located on the same level as that of devices on a predetermined network; provides an environment where an administrator of the network can set a communication control rule capable of cutting off communication between the devices when necessary; while administering the set communication control rules in a database, provides an ARP packet in which the data link layer address is manipulated, to the devices that are set as the objects of communication cut-off, such that data packets transmitted by the communication cut-off object devices are made to be transmitted to an manipulated abnormal address; and by doing so, cuts off communication between the communication cut-off object devices.
